(19) United States
(12) Patent Application Publication
(10) Pub. No.: US 2008/0043137 A1
(43) Pub. Date: Feb. 21, 2008

(54) Apparatus, Method and System for Image Forming

(75) Inventors: Yuji Rikima, Numazu-shi (JP); Noboru Ogino, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/462,975

(22) Filed: Aug. 7, 2006

(51) Int. Cl. H04N 5/238

(52) U.S. Cl. 348/364

(57) ABSTRACT

An image forming apparatus includes a digital multi function peripheral (MFP) body, an external controller that is connected to an external apparatus via a network and exchanges data with the MFP body, plural communication units that signal-connect the MFP and the external controller, and an operation panel provided in the MFP body. The MFP body displays operation content for setting a configuration of the external controller on the operation panel on the basis of screen data from the external controller.

### BACKGROUND OF THE INVENTION

1. Field of the Invention

The present invention relates to an apparatus, a method, and a system for image forming that use a Multi Function Peripheral (MFP).

2. Description of the Related Art

In recent years, a Multi Function Peripheral (MFP) that not only has a function of scanning and reading an image with designated resolution and sheet size but also has various kinds of functions such as an image receiving function by a facsimile, an image receiving function by an email, and a print image receiving function by a network has been widely used.

An external controller that exchanges information with an external apparatus serving as an information processing terminal such as a personal computer (PC) and plays roles such as improvement of functions and efficiency of operation of the MFP is connectable to this MFP. According to the improvement of functions of the MFP, functions of the external controller have been diversified and sophisticated.

As a conventional technique, there is known an image processing system using the MFP in which a change of an operation panel of a printer and remote operation from a PC can be easily performed.

This image processing system includes a printer that has an operation panel mounted with a controller, an HTTP daemon with HTML, a proxy, and a WWW browser function, a personal computer that can communicate with this operation panel, and a LAN (JP-A-2002-86847).

### BRIEF SUMMARY OF THE INVENTION

An image forming apparatus according to a first aspect of the invention includes: a digital multi function peripheral (MFP) body; an external controller that is connected to an external apparatus via a network and exchanges data with the MFP body; plural communication units that signal-connect the MFP and the external controller; and an operation panel provided in the MFP body. The MFP body displays operation content for setting a configuration of the external controller on the operation panel on the basis of screen data from the external controller.

An image forming method according to a second aspect of the invention is an image forming method for an image forming apparatus including: a digital multi function peripheral (MFP) body; an external controller that is connected to an external apparatus via a network and exchanges data with the MFP body; plural communication units that signal-connect the MFP and the external controller; and an operation panel provided in the MFP body. The MFP body displays operation content for setting a configuration of the external controller on the operation panel on the basis of screen data from the external controller.

An image forming system according to a third aspect of the invention is an image forming system including: one or more external apparatuses connected to a communication line; and one or more image forming apparatuses. Each of the image forming apparatuses includes: a digital multi function peripheral (MFP) body; an external controller that is connected to each of the external apparatuses via a network and exchanges data with the MFP body; plural communication units that signal-connect the MFP and the external controllers; and an operation panel provided in the MFP body. The MFP body displays operation content for setting a configuration of the external controller on the operation panel on the basis of screen data from the external controller.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a system diagram of an image forming system according to an embodiment of the invention;

FIG. 2 is a block diagram showing an internal structure of an MFP body;

FIG. 3 is an external view of an operation panel provided in the MFP body;

FIG. 4 is an external view of an operation panel provided in an external controller in the past;

FIG. 5 is a diagram schematically showing an operation for displaying operation content for performing configuration setting for the external controller on the operation panel;

FIG. 6 is a sequence chart showing an information exchange procedure in performing setting in the external controller;

FIG. 7 is a sequence chart showing an information exchange procedure in updating a Web browser screen;

FIG. 8 is a sequence chart showing an information exchange procedure in requesting update of display on the Web browser screen;

FIG. 9 is a sequence chart showing an information exchange procedure in allocating functions to respective buttons of the operation panel; and

FIG. 10 is a sequence chart showing an information exchange procedure in locking functions of an operation panel of an image forming apparatus.

### DETAILED DESCRIPTION OF THE INVENTION

An embodiment of the invention will be hereinafter explained with reference to the drawings.

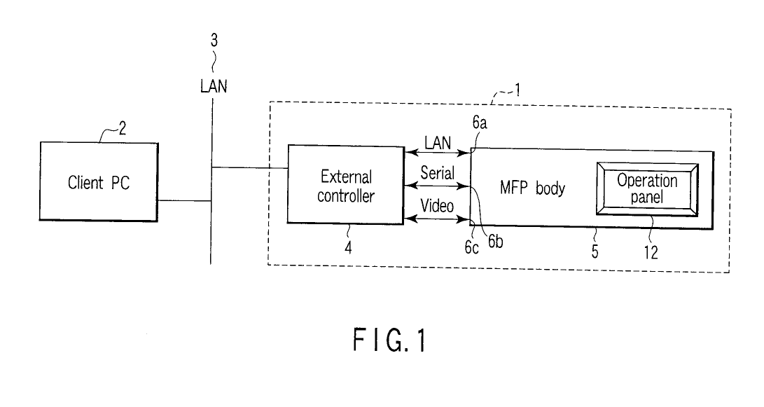

FIG. 1 is a system diagram of an image forming system according to the embodiment of the invention.

This image forming system includes an image forming apparatus 1, a client PC 2, and a communication line 3 that connects the image forming apparatus 1 and the client PC 2.

The image forming apparatus 1 prints an image acquired by scanning or communication and transmits the image acquired to the outside. The client PC 2 converts data such as an image or a document created by a user into data of a predetermined print format and sends the data to the image forming apparatus 1 or acquires, from the image forming apparatus 1, an image scanned and acquired. The client PC 2 can manipulate operations of the image forming apparatus 1.

The communication line 3 is, for example, a local area network (LAN) of the Ethernet system. This image forming system is not limited to the form shown in FIG. 1. It is possible to connect plural image forming apparatuses 1 and plural client PCs 2 to the communication line 3.

The image forming apparatus 1 includes an external controller 4, an MFP body 5 that has an operation panel 12, and a communication line 6 that connects the external controller 4 and the MFP body 5.

The external controller 4 is connected to the client PC 2 via a LAN and is connected to the MFP body 5 via a communication line 6 described later. The external controller 4 executes a printer function and a scanner function. For example, the external controller 4 subjects print data transmitted from the client PC 2 to image processing to change the print data to print data of a format that the MFP body 5 can handle and transmits the print data to the MFP body 5. The external controller 4 receives image data scanned by the MFP body 5 and transfers the image data to the client PC 2.

The MFP body 5 has a Web browser function. The external controller 4 has a Web server function. Therefore, the MFP body 5 and the external controller 4 can exchange information with each other via this Web function.

The MFP body 5 and the external controller 4 are connected via a local area network (LAN) interface 6a, a serial signal interface 6b, and a video signal interface 6c.

The LAN interface 6a transfers registration information of a print job, image data scanned, and the like according to the Ethernet system. The serial signal interface 6b transfers a signal necessary for print processing. The video signal interface 6c transfers an image signal.

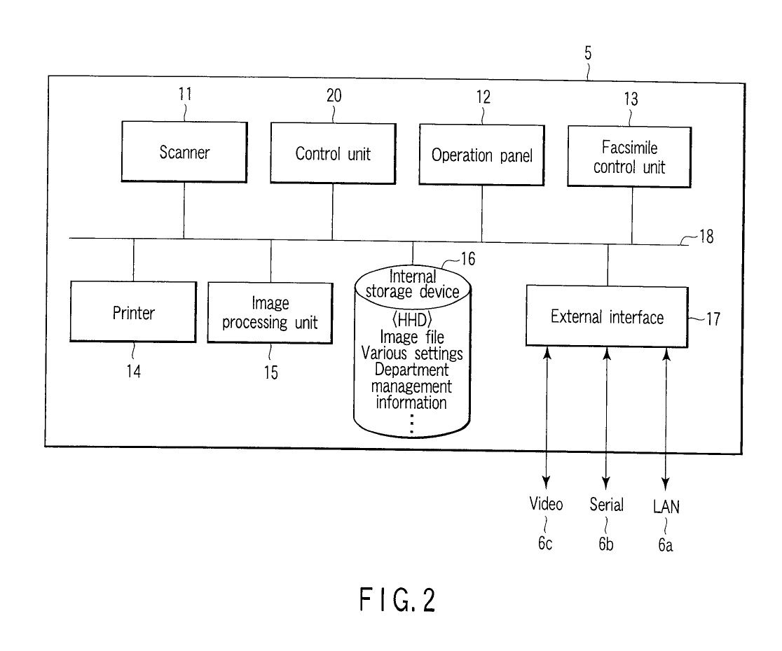

FIG. 2 is a block diagram showing an internal structure of the MFP body 5.

The MFP body 5 includes a scanner 11, the operation panel 12, a facsimile control unit 13, a printer 14, an image processing unit 15, an internal storage device 16, an external interface 17, a system bus 18, and a control unit 20.

The scanner 11 captures image information from an original as image data. The operation panel 12 captures instructions for setting and execution of various functions inputted by the user and displays and notifies the user of necessary information. The facsimile control unit 13 is an interface for performing facsimile communication between the MFP body 5 and an external apparatus (not shown) via a public telephone network PSTN.

The printer 14 outputs an image to a sheet. The image processing unit 15 subjects image data captured by the scanner 11 to high image quality processing such as smoothing. The internal storage device 16 is a storage medium such as an HDD set in the inside of the MFP body 5. Image files, various kinds of setting information, department management information, and the like are stored in this internal storage device. The external interface 17 is an interface for performing exchange of various kinds of setting information, control information, and image data with the external controller 4. The control unit 20 controls the respective hardware units connected via the system bus 18.

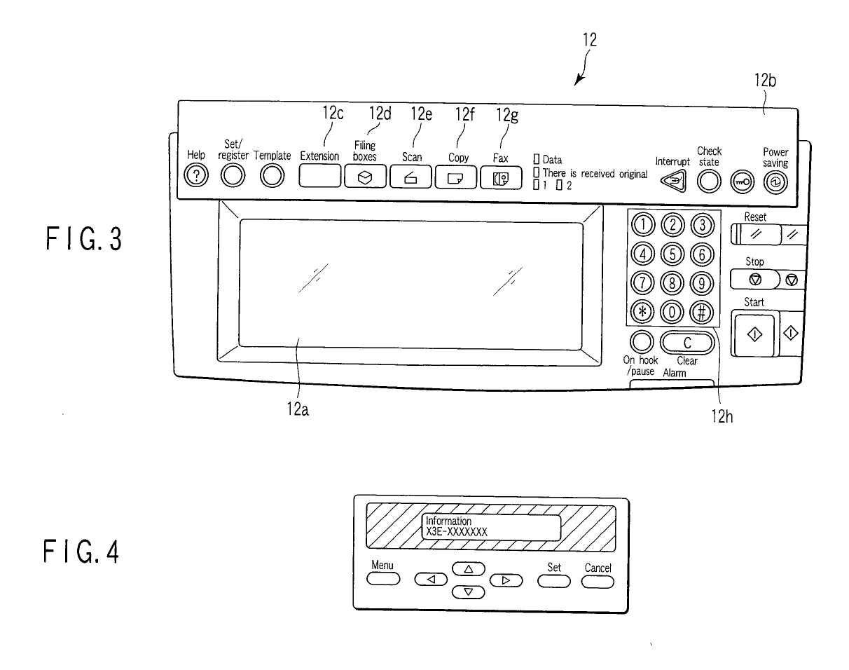

FIG. 3 is an external view of the operation panel 12 provided in the MFP body 5.

In this embodiment, the user performs setting and check for the MFP body 5 via this operation panel.

In the conventional image forming apparatus, an operation panel shown in FIG. 4 is provided to the external controller 4. However, the conventional operation panel can display only about two lines of character strings because of limitation of an implementation form, cost, and the like. In addition, only a few operation buttons are provided. Therefore, when the user performs configuration setting (network setting, printer function setting, etc.) for the external controller, in inputting data, the user has to manipulate the operation panel repeatedly. This makes operation complicated.

In this embodiment, the operation panel 12 provided in the MFP body 5 is an operation panel obtained by adding functions of the conventional operation panel of the external controller 4 to functions for manipulating the MFP body 5 and aggregating the functions.

A structure of a panel surface of the operation panel 12 will be explained with reference to FIG. 3.

A touch panel 12a and an operation input unit 12b are provided in the operation panel 12.

A state of the image forming apparatus 1, an operation procedure, various instructions to the user, and the like are displayed on the touch panel 12a. An information Web browser screen is displayed on this touch panel 12a by switching display content.

Various operation buttons for operating the image forming apparatus 1 is provided on the operation input unit 12b.

As keys for invoking screens for selecting and setting functions, a function extension button 12c, a filing box button 12d, a scan button 12e, a copy 12f, a fax button 12g, and the like are arranged. Besides, number keys 12h and the like for inputting setting values and checking information are also arranged.

Functions of main buttons among these operation buttons will be explained.

The extension button 12c is used in switching a usual screen and a browser screen. The filing box button 12d is used in extracting image data stored. The scan button 12e is used in using the scan function. The copy button 12f is used in using the copy function. The fax button 12g is used in using the fax function. The ten keys 12h are used in entering numbers.

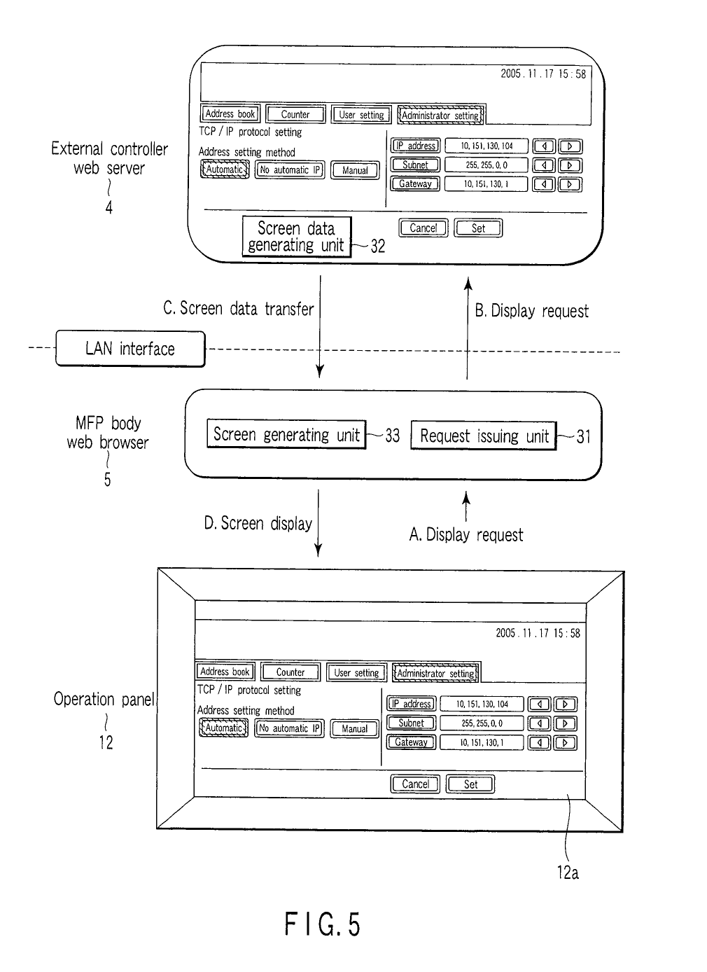

FIG. 5 is a diagram schematically showing an operation for displaying operation content for performing configuration setting for the external controller 4 on the operation panel 12.

As described above, the MFP body 5 has the Web browser function and the external controller 4 has the Web server function.

(A) When the user performs operation for requesting display of a browser screen from the operation panel 12, (B) a request issuing unit 31 of the MFP body 5 transmits a display request signal to the external controller 4 via the LAN interface 6a.

(C) In the external controller 4, a screen data generating unit 32 edits data for displaying an apparatus setting screen in accordance with the request. In FIG. 5, an apparatus setting screen image is shown. The image data generating unit 32 transfers the apparatus setting screen data to the HFP body 5 using the Web browser function.

(D) In the MFP body 5, a screen generating unit 33 displays the apparatus setting screen on the touch panel 12a of the operation panel 12 using the Web browser function on the basis of the apparatus setting screen data transmitted.

The user can perform apparatus setting, which is a function of the external controller 4 in the past, from the display panel 12. Similarly, it is possible to display warning, error, and the like issued from the external controller 4 on the display panel 12.

An information exchange procedure between the MFP body 5 and the external controller 4 will be explained.

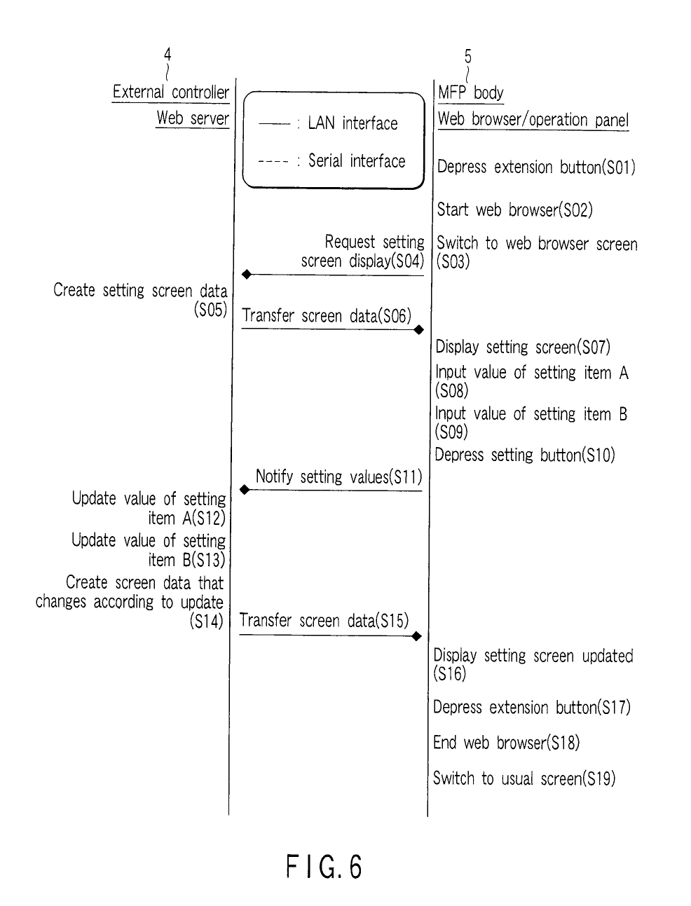

FIG. 6 is a sequence chart showing an information exchange procedure in performing setting for the external controller. Operations of the external controller 4 are shown on the left side of FIG. 6 and operations of the MFP body 5 are shown in the right side of FIG. 6. Contents of signals transferred via the communication line 6 are described in the center of FIG. 6. In display in the center, signals flowing through the LAN interface 6a are indicated by solid lines and signals flowing through the serial signal interface 6b are indicated by dotted lines.

When the user depresses the extension button 12c in the operation input unit 12b of the operation panel 12 in step S01, in step S02, a Web browser is started. When the Web browser is started, in step S03, a screen on the operation panel 12 is switched to a Web browser screen. In parallel with this switching of the screen, in step S04, a request for display of a setting screen is issued to the Web server of the external controller 4.

When the Web server receives the display request, in step S05, the Web server creates data of the setting screen to be displayed on the operation panel 12. In step S06, the Web server transfers the screen data created to the Web browser of the MFP body 5.

When the Web browser receives the screen data, in step S07, the Web browser displays the setting screen on the operation panel 12 in accordance with the screen data. In step S08, the user inputs a value of an item A in accordance with the setting screen displayed. In step S09, the user inputs a value of an item B. In order to decide values inputted last, in step S10, the user depresses a setting button displayed on the display panel 12. When the setting button is depressed, in step S11, the Web browser notifies the Web server of the setting values inputted.

When the Web server receives the setting values, in step S12, the Web server updates a value of the item A in the external controller 12. In step S13, the Web server updates a value of the item B. When the values of the respective items are updated, in step S14, the Web server creates data of a screen reflecting the values updated. In step S15, the Web server transfers the screen data to the Web browser.

When the Web browser receives the screen data, in step S16, the Web browser displays the setting screen updated on the operation panel 12 in accordance with the screen data.

When the setting operation for the external controller 4 is completed, in step S17, the user depresses the extension button 12c. Then, in step S18, the Web browser ends. In step S19, the display on the operation panel 12 is switched to the usual screen.

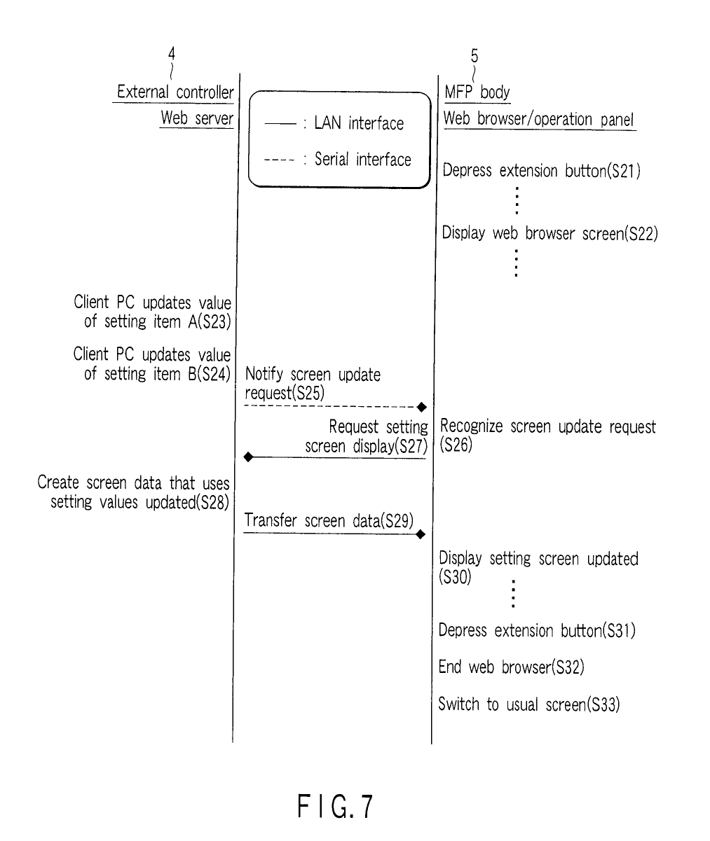

FIG. 7 is a sequence chart showing an information exchange procedure in updating the Web browser screen.

Information exchange in this case is executed in a form in which the LAN interface and the serial signal interface 6b are combined.

According to operation in step S21 performed by the user, in step S22, the Web browser screen is displayed on the operation panel 12.

In steps S23 and S24, a value of the setting item A and a value of the setting item B are updated according to operation from the client PC 2 applied to the external controller 4. In step S25, the external controller 4 sends a notice of the update of the Web browser screen to the MFP body 5 via the serial signal interface 6b.

When the MFP body 1 recognizes a screen update request in step S26, in step S27, the MFP body issues a request for display of the setting screen to the external controller 4 through the LAN interface.

When the external controller 4 receives this request, in step S28, the external controller 4 creates screen data reflecting the setting values updated In step S29, the external controller 4 transfers the screen data created to the MFP body 5.

In step S30, the MFP body 5 displays the updated screen data received. Thereafter, according to operation in steps S31 to S33 by the user, the display on the operation panel 12 returns to the usual screen.

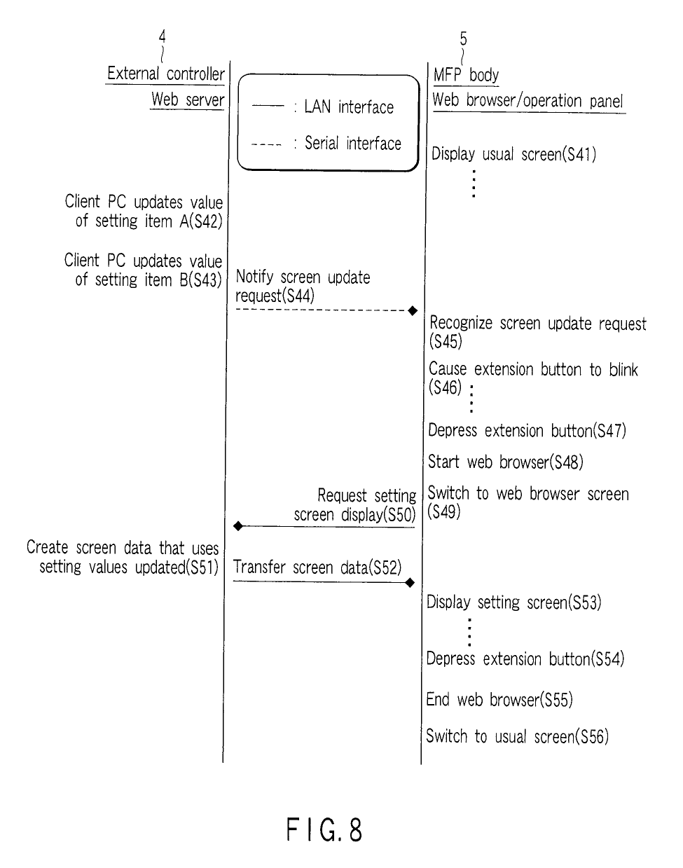

FIG. 8 is a sequence chart showing an information exchange procedure in requesting update of display on the Web browser screen. This is an example of a sequence between the external controller 4 and the MFP body 5 in the case in which the external controller 4 updates content of the Web browser screen when the MFP body 5 does not display the Web browser screen.

Information exchange in this case is executed in a form in which the LAN interface 6a and the serial signal interface 6b are combined.

In step S41, the usual screen is displayed on the operation panel 12.

In steps S42 and S43, a value of the setting item A and a value of the setting item B are updated according to operation from the client PC 2 applied to the external controller 4. In step S44, the external controller 4 sends a notice of a request for updating the Web browser to the MFP body 5 via the serial signal interface 6b.

In step S45, the MFP body 5 recognizes the screen update request. At present, the operation panel 12 does not display the Web browser screen. Thus, in step S46, in order to notify the user that the display on the Web browser screen is updated, the MFP 5 causes a lamp of the extension button 12c of the operation panel 12 to blink.

The user notices the blinking of the lamp of the extension button 12c. In step S47, the user depresses the extension button 12c. Then, in step S48, the Web browser is started. In step S49, the display on the operation panel 12 is switched to the Web browser screen. In step S50, a request for display of the setting screen is issued to the external controller 4.

In step S51, the external controller 4 creates screen data that uses the setting values updated. In step S52, the external controller 4 transfers the screen data created to the MFP body 5.

In step S53, the MFP body 5 displays the updated screen data received. According to operation in steps S54 to S56 by the user, the display on the operation panel 12 returns to the usual screen.

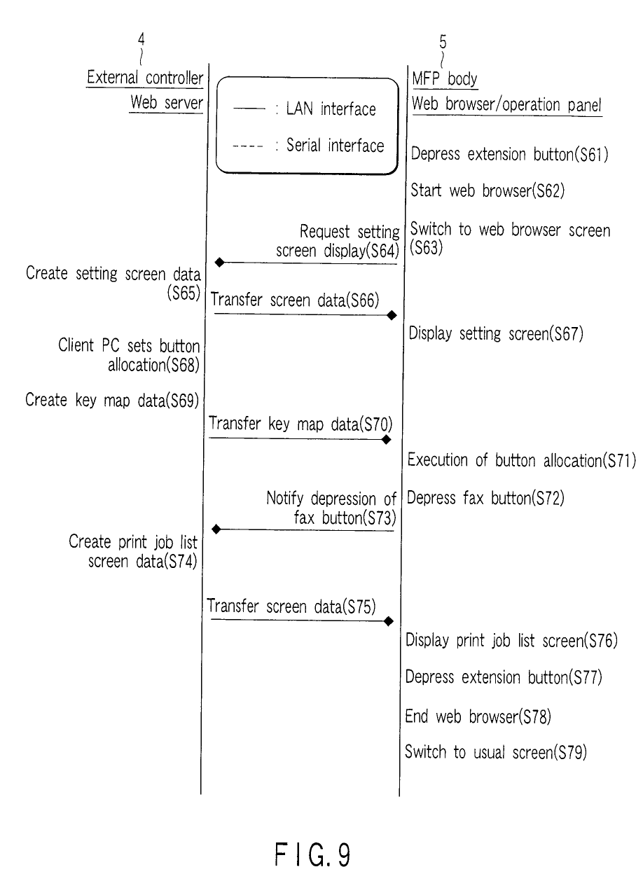

FIG. 9 is a sequence chart showing an information exchange procedure in allocating functions to respective buttons of the operation panel.

When the user depresses the extension button 12c in the operation input unit 12b of the operation panel 12 in step S61, in step S62, the Web browser is started. When the Web browser is started, in step S63, the screen of the operation panel 12 is switched to the Web browser screen. In parallel with this switching of the screen, in step S64, a request for display of the setting screen of the external controller 4 is issued to the Web server of the external controller 4.

When the Web server receives the display request, in step S65, the Web server creates data of the setting screen to be displayed on the operation panel 12. In step S66, the Web server transfers the screen data created to the Web browser of the MFP body 5.

When the Web browser receives the screen data, in step S67, the Web browser displays the setting screen on the operation panel 12 in accordance with the screen data.

In step S68, setting of allocation of functions of the buttons of the operation panel 12 is performed according to operation from the client PC 2 applied to the external controller 4. For example, a function of displaying a print job list in the external controller is allocated to the fax button 12g. Besides, a scan list output function, a setup screen display function, and the like are allocated to the buttons of the operation panel 12.

When the allocation setting from the client PC 2 is performed, in step S69, key map data, which is information on allocation of the functions of the operation panel 12, is created. The key map data created is transferred to the LAFP body 5 in step S70.

In step S71, the MFP body 5 performs allocation of functions to the buttons in accordance with the key map data received. In this example, allocation for notifying the external controller 4 that the fax button 12g is depressed is performed. After the function allocation is performed, when the user depresses the fax button 12g in step S72, in step S73, a notice of depression of the fax button is transmitted.

When the external controller 4 receives the notice of depression of the fax button, the external controller 4 recognizes the notice as a request for display of the print job list in the external controller. In step S74, the external controller creates display screen data for the print job list. In step S75, the external controller 4 transfers the screen data to the Web browser of the MFP body 5.

In step S76, the Web browser displays the display screen for the print job list received. When the user depresses the extension button 12c in step S77, in step S78, the display of the Web browser screen ends. In step S79, the display on the operation panel 12 is switched to the usual screen.

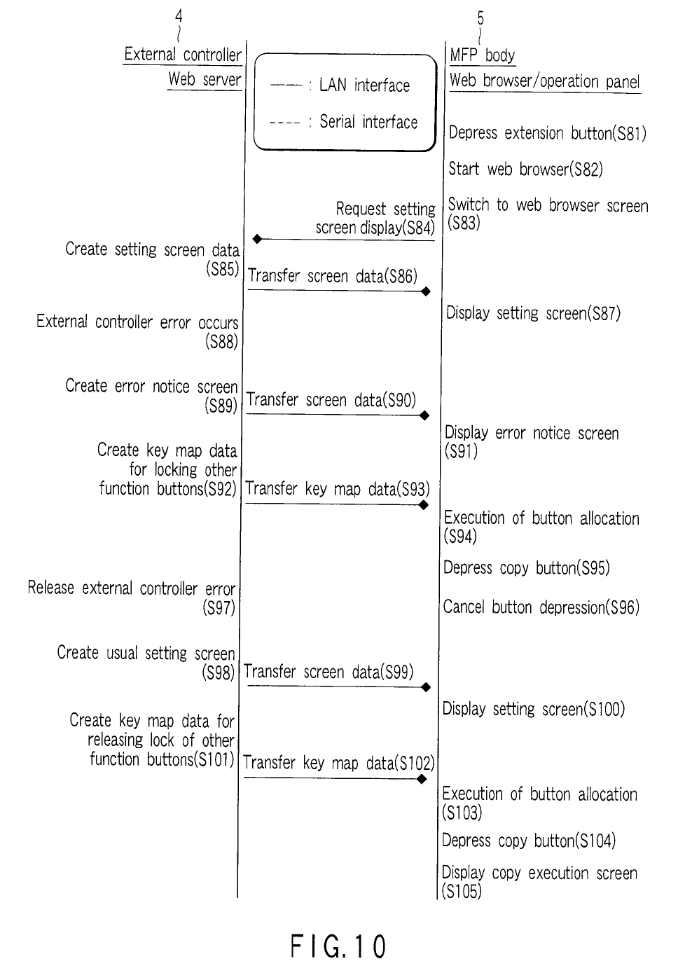

FIG. 10 is a sequence chart showing an information exchange procedure in locking functions of the operation panel of the image forming apparatus.

When the user depresses the extension button 12c in the operation input unit 12b of the operation panel. 12 in step S81, in step S82, the Web browser is started. When the Web browser is started, in step S83, the screen of the operation panel 12 is switched to the Web browser screen. In parallel with this switching of the screen, in step S84, a request for display of the setting screen of the external controller 4 is issued to the Web server of the external controller 4.

When the Web server receives the display request, in step S85, the Web server creates data of the setting screen to be displayed on the operation panel 12. In step S86, the Web server transfers the screen data created to the Web browser of the MFP body 5.

When the Web browser receives the screen data, in step S87, the Web browser displays the setting screen on the operation panel 12 in accordance with the screen data.

In step S88, the external controller 4 detects an error. An error is detected, for example, when an image generation memory is insufficient in the external controller 4 or when an error occurs in a signal exchange procedure. In other words, the external controller 4 judges that it is difficult to continue an operation.

In step S89, the external controller 4 creates an error notice screen. In step S90, the external controller 4 transfers error notice screen data to the Web browser.

In step S91, the Web browser displays the error notice screen on the display panel.

In step S92, to prevent the error notice screen displayed from being erased by depression of the function button such as the copy button 12f of the display panel 12, the external controller 4 creates key map data for locking the other function buttons. In step S93, the external controller 4 transfers the key map data created to the MFP body 5.

When the MFP body 5 receives the key map data, in step S94, the MFP body 5 executes allocation of the functions of the buttons. The respective buttons are set to an invalid state according to this function allocation. Even if the user depresses the copy button 12f in step S95 in this state, in step S96, the depression of the button is canceled. Therefore, the screen of the Web browser remains in the state in which the error is displayed.

When the state of the error of the external controller 4 is released in step S97, in step 98, the external controller 4 creates usual setting screen data. In step S99, the external controller 4 transfers the setting screen data created to the MFP body 5.

The screen data transferred is displayed on the Web browser in step S100.

In step S101, the external controller 4 creates a key map data for releasing the lock of the other function buttons, or designating the usual function allocation. In step S102, the external controller 4 transfers the key map data created to the MFP body 5.

When the MFP body 5 receives the key map data, in step S103, the MFP body 5 executes allocation of the functions to the buttons. The functions of the buttons are set to a valid state according to this allocation. When the user depresses the copy button 12f in step S104 in this state, an execution screen for copy is displayed on the operation panel 12 in step S105.

As explained above, according to the embodiment of the invention, the operation panel of the external controller 4 is made unnecessary and cost reduction can be realized. It is possible to use the large touch panel and the large number of buttons of the operation panel 12 of MFP body 5. Consequently, operability of operation input, check, and the like is improved. Since it is possible to operate the MFP body 5 and the external controller 4 with one operation panel, the image forming system is a system convenient for the user.

The respective functions explained in the embodiment may be constituted using hardware or the functions may be realized by causing a computer to read a program describing the respective functions using software. The respective functions may be constituted by appropriately selecting software or hardware,

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a digital multi function peripheral (MFP) body;
an external controller that is connected to an external apparatus via a network and exchanges data with the MFP body;
plural communication units configured to signal-connect the MFP and the external controller; and
an operation panel provided in the MFP body, wherein
the MFP body displays operation content for setting a configuration of the external controller on the operation panel on the basis of screen data from the external controller.

2. An image forming apparatus according to claim 1, wherein
the MFP body is mounted with a Web browser function,
the external controller is mounted with a Web server function, and
the MFP body displays the screen data transmitted by the Web server function of the external controller on the operation panel using the Web browser function.

3. An image forming apparatus according to claim 2, wherein
the MFP body further includes a screen data request issuing unit configured to request the external controller to generate Web screen data as required, and
the external controller further includes a screen data generating unit configured to generate the Web screen data and transmit the Web screen data to the MFP body in response to the request from the MFP body.

4. An image forming apparatus according to claim 3, wherein the external controller further includes a screen update notifying unit configured to notify, when operation for correcting the Web screen data is performed by the external apparatus, the MFP body that screen update is performed.

5. An image forming apparatus according to claim 4, wherein, when the screen data request issuing unit receives a notice indicating that the screen update is performed from the external controller, the screen data request issuing unit requests the external controller to generate the Web screen data when the Web screen data is displayed on the operation panel and performs output for calling for attention on the operation panel when the Web screen data is not displayed on the operation panel.

6. An image forming apparatus according to claim 3, wherein the external controller further includes a map data transmitting unit configured to transmit, when operation for changing allocation of functions of operation buttons of the operation panel is performed by the external apparatus, new function allocation data of the operation buttons to the MFP body.

7. An image forming apparatus according to claim 6, wherein the MFP body further includes an allocation changing unit configured to change, when the new function allocation data of the operation buttons is received from the external controller, the function allocation of the operation buttons on the basis of the data.

8. An image forming apparatus according to claim 7, wherein the new function allocation data of the operation buttons invalidates operation of an arbitrary operation button.

9. An image forming apparatus according to claim 1, wherein the plural communication units that signal-connect the MEP and the external controller include at least a LAN interface, a serial signal interface 6b, and a video interface.

10. An image forming method for an image forming apparatus including: a digital multi function peripheral (MFP) body; an external controller that is connected to an external apparatus via a network and exchanges data with the MFP body; plural communication units that signal-connect the MFP and the external controller; and an operation panel provided in the MFP body, wherein
the MFP body displays operation content for setting a configuration of the external controller on the operation panel on the basis of screen data from the external controller.

11. An image forming method according to claim 10, wherein
the MFP body is mounted with a Web browser function,
the external controller is mounted with a Web server function, and
in the MFP body, the screen data transmitted by the Web server function of the external controller is displayed on the operation panel by the Web browser function.

12. An image forming method according to claim 11, wherein
in the MFP body, the external controller is requested to generate Web screen data as required, and
in the external controller, the Web screen data is generated and transmitted to the MFP body in response to the request from the MFP body.

13. An image forming method according to claim 12, wherein, in the external controller, when operation for correcting the Web screen data is performed by the external apparatus, it is notified to the MFP body that screen update is performed.

14. An image forming method according to claim 13, wherein, in the request for Web screen data to the external controller, when a notice indicating that the screen update is performed is received from the external controller, the external controller is requested to generate the Web screen data when the Web screen data is displayed on the operation panel, and output for calling for attention is performed on the operation panel when the Web screen data is not displayed on the operation panel.

15. An image forming method according to claim 12, wherein, in the external controller, when operation for changing allocation of functions of operation buttons of the operation panel is performed by the external apparatus, new function allocation data of the operation buttons is transmitted to the MFP body.

16. An image forming method according to claim 15, wherein, in the MFP body, when the new function allocation data of the operation buttons is received from the external controller, the function allocation of the operation buttons is changed on the basis of the data.

17. An image forming method according to claim 16, wherein the new function allocation data of the operation buttons invalidates operation of an arbitrary operation button.

18. An image forming method according to claim 10, wherein the plural communication units that signal-connect the MFP and the external controller include at least a LAN interface, a serial signal interface 6b, and a video interface.

19. An image forming system comprising:
one or more external apparatuses connected to a communication line; and
one or more image forming apparatuses, wherein
each of the image forming apparatuses includes:
a digital multi function peripheral (MFP) body;
an external controller that is connected to each of the external apparatuses via a network and exchanges data with the MFP body;
plural communication units that signal-connect the MFP and the external controllers; and
an operation panel provided in the MFP body, wherein
the MFP body displays operation content for setting a configuration of the external controller on the operation panel on the basis of screen data from the external controller.

20. An image forming system according to claim 19, wherein
the MFP body is mounted with a Web browser function,
the external controller is mounted with a Web server function, and
the MFP body displays the screen data transmitted by the Web server function of the external controller on the operation panel using the Web browser function.
